(19) United States
(12) Patent Application Publication
(10) Pub. No.: US 2008/0146412 A1
(43) Pub. Date: Jun. 19, 2008

(54) VEHICULAR POWER OUTPUTTING APPARATUS AND METHOD THEREOF

(75) Inventors: Ayumu SAGAWA, Toyota-shi (JP); Koji Oshima, Nagoya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/953,379

(22) Filed: Dec. 10, 2007

(30) Foreign Application Priority Data
Dec. 13, 2006 (JP) 2006-336020

(51) Int. Cl. B60W 10/04; F02D 13/06; F02D 41/00

(52) U.S. Cl. 477/108; 123/198 F; 701/103

(57) ABSTRACT

A control apparatus of a vehicular power outputting apparatus, which temporarily increases the rotation speed of an input rotating element provided in an automatic transmission using an engine during a downshift in the automatic transmission, is provided with cylinder reduction controlling means for performing a cylinder reduction control that stops at least some of a plurality of cylinders provided in the engine from generating power during a downshift of the automatic transmission. As a result, pumping loss of the engine is reduced which enables the speed of the engine to be increased faster, thus improving shift response.

### INCORPORATION BY REFERENCE

The disclosure of Japanese Patent Application No. 2006-336020 filed on Dec. 13, 2006, including the specification, drawings and abstract is incorporated herein by reference in its entirety.

### BACKGROUND OF THE INVENTION

1. Field of the Invention

The invention relates to a vehicular power outputting apparatus that outputs power to drive a vehicle and control method thereof. More particularly, the invention relates to technology for improving shift response.

2. Description of the Related Art

Various kinds of vehicles use a vehicular power outputting apparatus that outputs power for running a vehicle and which includes an internal combustion engine that has a plurality of cylinders for generating power to drive the vehicle and a stepped transmission that transmits the power generated by the internal combustion engine to a drive shaft. One example of such a control apparatus for a vehicular power outputting apparatus is the control apparatus for an automatic transmission described in Japanese Patent Application Publication No. 9-229180 (JP-A-9-229180), which performs a constant velocity shift during a downshift of the stepped transmission. This control apparatus makes it possible to correct the initial hydraulic pressure of friction apply devices to be applied in the automatic transmission during a constant velocity shift at the time of a downshift by determining whether, during a so-called clutch-to-clutch shift, that shift is a shift that will temporarily increase the speed of the internal combustion engine, and then temporarily increasing the output of the internal combustion engine according to that determination.

However, in JP-A-9-229180, it takes a relatively long time to increase the speed of the internal combustion engine due to pumping loss of the internal combustion engine and response delay of the electronic throttle valve and the like so there was a limit as to just how much the shift response of the stepped transmission could be improved. Therefore, there is a need to develop a control apparatus for a vehicular power outputting apparatus, which improves shift response by quickly increasing the speed of the internal combustion engine.

### SUMMARY OF THE INVENTION

This invention thus provides a vehicular power outputting apparatus and control method thereof, which improves shift response.

A first aspect of the invention relates to a vehicular power outputting apparatus which includes an internal combustion engine having a plurality of cylinders for generating power to drive a vehicle, and a stepped transmission that transmits the power generated by the internal combustion engine to a drive shaft. This vehicular power outputting apparatus includes a controller which temporarily increases the rotation speed of an input rotating element provided in the stepped transmission using the internal combustion engine during a downshift of the stepped transmission. Further, the controller performs a cylinder reduction control that stops at least some of a plurality of cylinders provided in the internal combustion engine from generating power during a downshift of the stepped transmission.

According to this structure, pumping loss of the internal combustion engine can be reduced, which enables the speed of the internal combustion engine to be increased faster. That is, a control apparatus for a vehicular power outputting apparatus, which improves shift response can be provided.

Here, the opening amount of a throttle valve for controlling an amount of intake air allowed into the internal combustion engine may be set larger when the controller performs the cylinder reduction control than it is when the controller does not perform the cylinder reduction control. Accordingly, a decrease in the output torque of the internal combustion engine that would otherwise occur as a result of the cylinder reduction control can be suppressed while the shift response can be improved.

Also, the controller may perform the cylinder reduction control during a downshift of the stepped transmission according to a manual operation. Accordingly, the shift response during a manual downshift can be improved.

Also, the controller may perform the cylinder reduction control during a downshift of the stepped transmission as a result of a kickdown. Accordingly, the shift response during a kick downshift can be improved.

A second aspect of the invention relates to a control method for a vehicular power outputting apparatus. This control method includes the steps of: determining whether a downshift condition of a stepped transmission of the vehicular power outputting apparatus is satisfied, and, when the downshift condition is satisfied, performing a cylinder reduction control that stops at least some of a plurality of cylinders provided in an internal combustion engine of the vehicular power outputting apparatus from generating power and temporarily increasing the rotation speed of an input rotating element provided in the stepped transmission using the internal combustion engine.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a skeleton view of a vehicular power outputting apparatus according to an example embodiment of the invention;

FIG. 2 is a clutch and brake application chart showing various application and release combinations of clutches and brakes to achieve a plurality of speeds in an automatic transmission provided in the vehicular power outputting apparatus shown in FIG. 1;

FIG. 3 is a circuit diagram showing the main parts of a hydraulic control circuit provided in the vehicular power outputting apparatus shown in FIG. 1, which are related to shifting in the automatic transmission;

FIG. 4 is a block line diagram illustrating an electrical control system provided in the vehicle for controlling the vehicular power outputting apparatus and the like shown in FIG. 1;

FIG. 5 is a detailed view of a valve driving controller provided in an engine of the vehicular power outputting apparatus shown in FIG. 1;

FIG. 6 is a detailed view of the structure of electromagnetic actuators provided in the valve driving controller;

FIG. 7 is a perspective view of a shift lever for changing the shift position of the automatic transmission provided in the vehicular power outputting apparatus shown in FIG. 1;

FIG. 8 is a graph illustrating a predetermined relationship for controlling an electronic throttle valve in the vehicular power outputting apparatus shown in FIG. 1 open and closed;

FIG. 9 is a map illustrating a predetermined relationship for controlling shift operations in the automatic transmission of the vehicular power outputting apparatus shown in FIG. 1;

FIG. 10 is a functional block line diagram showing the main portions of control functions provided in an electronic control unit shown in FIG. 4;

FIG. 11 is a time chart illustrating the improvement in shift response in cylinder reduction control of this example embodiment which is executed by the electronic control unit shown in FIG. 4;

FIG. 12 is a flowchart illustrating the main part of a downshift control routine executed by the electronic control unit shown in FIG. 4; and

FIG. 13 is a flowchart illustrating an example of the main part of another downshift control routine executed by the electronic control unit shown in FIG. 4.

### DETAILED DESCRIPTION OF THE EMBODIMENTS

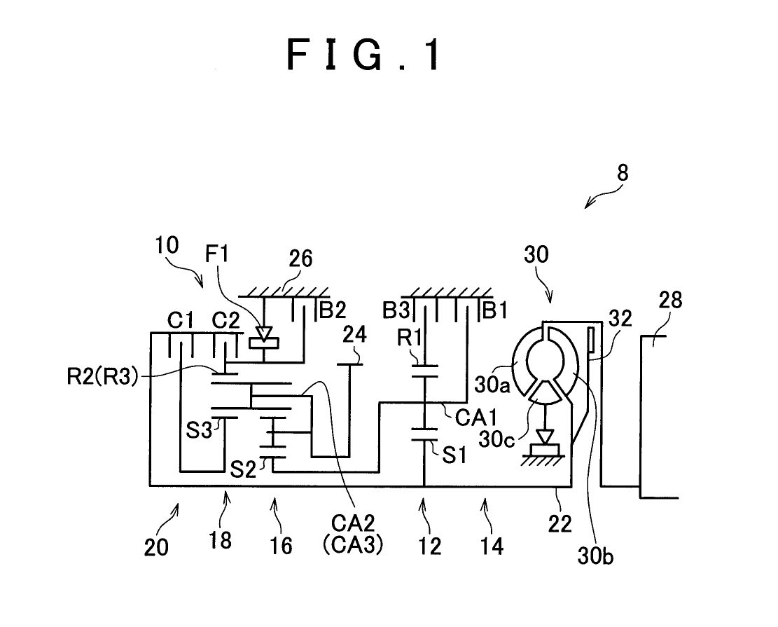

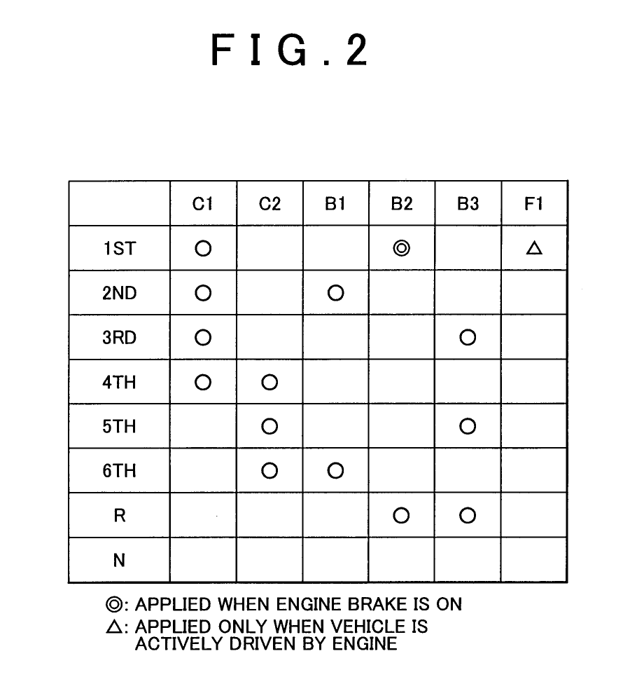

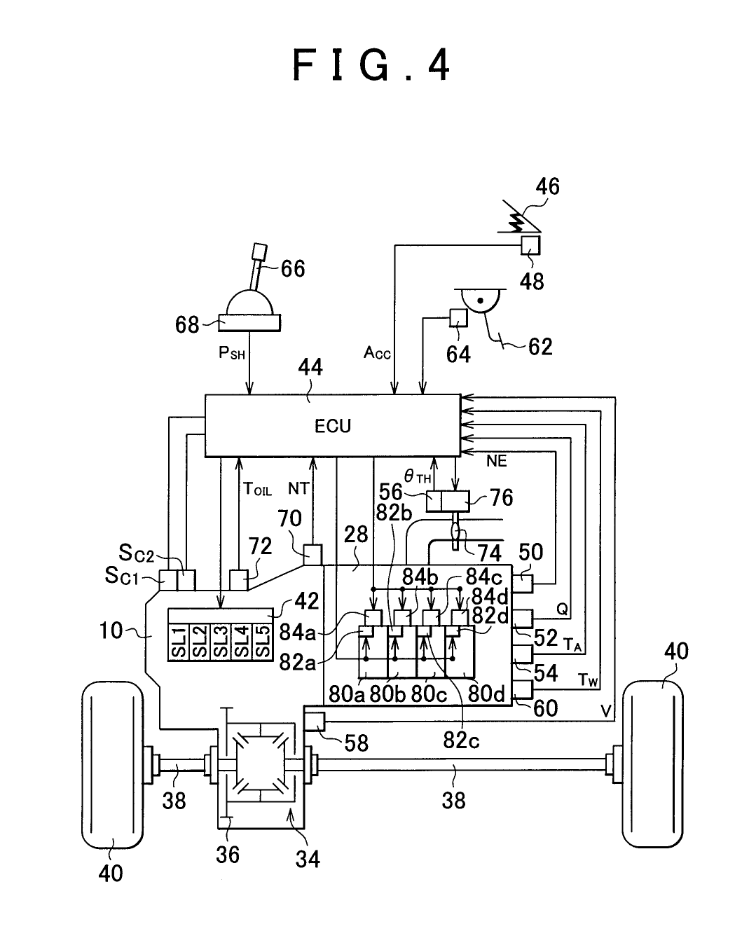

FIG. 1 is a skeleton view of the vehicular power outputting apparatus 8 according to an example embodiment of the invention. FIG. 2 is a clutch and brake application chart showing various application and release combinations of clutches and brakes to achieve a plurality of speeds in an automatic transmission 10 provided in the vehicular power outputting apparatus 8. This automatic transmission 10 is used in a FF (front engine-front wheel drive) vehicle or the like in which an engine is transverse mounted (i.e., mounted in the right-left or width direction) in the vehicle. The automatic transmission 10 has a first transmitting portion 14 and a second transmitting portion 20 provided on the same axis. The first transmitting portion 14 mainly consists of a single pinion type first planetary gear set 12. The second transmitting portion 20 is a Ravigneaux type planetary gear set that mainly consists of a double a double pinion type second planetary gear set 16 and a single pinion type third planetary gear set 18. The automatic transmission 10, i.e., the first transmitting portion 14 and the second transmitting portion 20, is used to appropriately change the rate and/or direction of rotation that is input from an input shaft 22 and output the changed rotation from an output rotating member 24. The input shaft 22 corresponds to an input member and in this example embodiment is a turbine shaft of a torque converter 30 that is rotatably driven by an engine 28 which is an internal combustion engine used to generate power to drive the vehicle. Also, the output rotating member 24 corresponds to an output member of the automatic transmission 10 and functions as an output gear, i.e., a differential driver gear, that is in mesh with a differential driven gear (a large diameter gear) 36 used to transmit power to a differential gear unit 34 shown in FIG. 4. Output from the engine 28 is transmitted to a pair of driving wheels (front wheels) 40 via the torque converter 30, the automatic transmission 10, the differential gear unit 34, and a pair of axles 38 which serve as drive shafts. Incidentally, the automatic transmission 10 has a generally symmetrical structure with respect to its center line so the half below the center line is omitted in FIG. 1.

The engine 28 is an internal combustion engine such as a gasoline engine or a diesel engine which includes a plurality of cylinders 80a to 80d (shown in FIG. 4) and generates power to drive the vehicle by burning fuel supplied to those cylinders 80a to 80d. The torque converter 30 is a fluid power transmitting device that uses fluid to transmit the power generated by the engine 28 to the automatic transmission 10, and includes a pump impeller 30a that is connected to a crankshaft of the engine 28, a turbine runner 30b which is connected to the input shaft 22 of the automatic transmission 10, and a stator 30c which is connected to a housing (i.e., the transmission case) 26 of the automatic transmission 10 via a one-way clutch. Also, a lockup clutch 32 which is a direct-coupled clutch is provided between the pump impeller 30a and the turbine runner 30b and can be placed in an applied state, a slip state, or a released state depending on the hydraulic control and the like. When the lockup clutch 32 is completely applied, the pump impeller 30a and the turbine runner 30b are made to rotate together as a single unit.

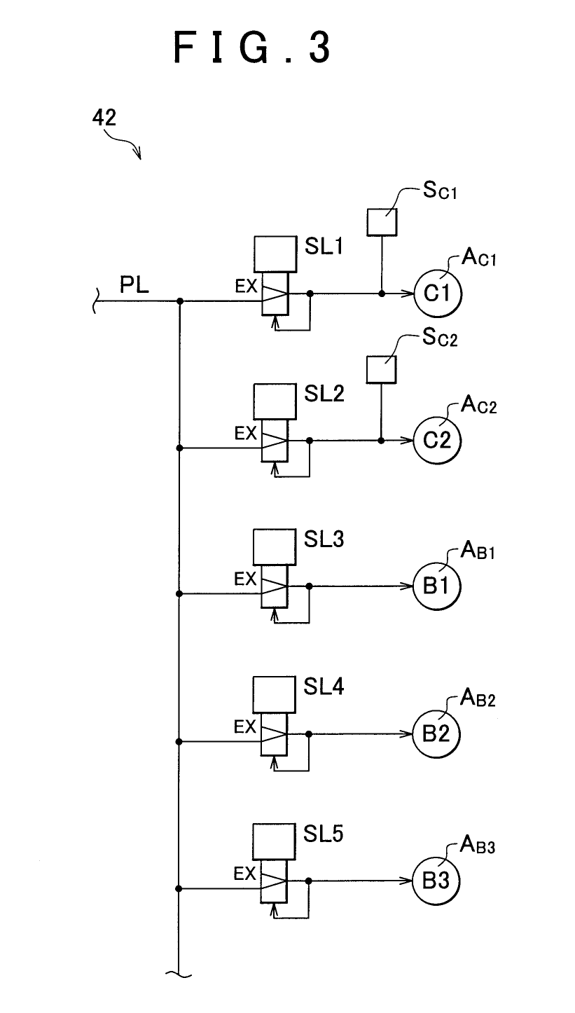

The clutch and brake application chart shown in FIG. 2 shows the relationship between the application state of the clutches and brakes and the various speeds that can be established by the automatic transmission 10. In the drawing, a circle indicates application, a double circle (bulls-eye) indicates application only when the engine brake is on, a triangle indicates application only when the vehicle is actively being driven by the internal combustion engine, and a blank space indicates release. The clutches C1 and C2 and brakes B1, B2, and B3 (hereinafter, these will simply be referred to as “clutches C” and “brakes B” when it is not necessary to distinguish among them) provided in the automatic transmission 10 are hydraulic friction apply devices such as multiple disc clutches and brakes that are controlled to apply by hydraulic actuators. These clutches C and brakes B are switched between an applied state and a released state by energizing and de-energizing linear solenoid valves SL1 to SL5 of a hydraulic control circuit 42 which will be described later with reference to FIG. 3, and the transient hydraulic pressure during application and release is controlled by controlling the current to those solenoid valves SL1 to SL5.

In the automatic transmission 10, six forward speeds, i.e., first speed “1st” to sixth speed “6th”, and one reverse speed “R” can be established depending on the specific combination of rotating elements (i.e., sun gears S1 to S3, carriers CA1 to CA3, and ring gears R1 to R3) of the first and second transmitting portions 14 and 20 used to transmit power. More specifically, as shown in FIG. 2, first speed “1st” is established by applying clutch C1 and brake B2. Second speed “2nd” is established by applying clutch C1 and brake B1. Third speed “3rd” is established by applying clutch C1 and brake B3. Fourth speed “4th” is established by applying clutches C1 and C2. Fifth speed “5th” is established by applying clutch C2 and brake B3. Sixth speed “6th” is established by applying clutch C2 and brake B1, and reverse “Rev” is established by applying brakes B2 and B3. Releasing all of the clutches C and brakes B places the automatic transmission 10 in a neutral state. In the automatic transmission 10 of this example embodiment, a one-way clutch F1 is provided in parallel with brake B2 that is used to establish first speed “1st” so it is not always necessary to apply brake B2 when taking off from a standstill (during acceleration). Also, the speed ratios of the speeds are set appropriately according to the gear ratio ρ1 of the first planetary gear set 12, the gear ratio ρ2 of the second planetary gear set 16, and the gear ratio ρ3 of the third planetary gear set 18. Incidentally, the gear ratio is obtained by dividing the number of teeth on the sun gear by the number of teeth on the ring gear, i.e., gear ratio=number of teeth on the sun gear/number of teeth on the ring gear. Also, a pair of hydraulic friction apply devices are applied to achieve a predetermined speed. However, in the event that there is a failure in one of the two hydraulic friction apply devices such that that device does not sufficiently apply, the automatic transmission 10 will revert to a neutral-fail state that produces a larger speed ratio than the speed ratio corresponding to the predetermined speed.

FIG. 3 is a circuit diagram showing parts of the hydraulic control circuit 42 provided in the vehicular power outputting apparatus 8 that are related to the linear solenoid valves SL1, SL2, SL3, SL4, and SL5. As shown in FIG. 3, in the hydraulic control circuit 42, hydraulic pressure corresponding to a command signal from an electronic control unit (hereinafter simply referred to as “ECU”) 44 is regulated (i.e., adjusted) by the linear solenoid valves SL1 to SL5 with the line pressure PL as the base pressure and supplied as the apply pressure to hydraulic actuators (e.g., hydraulic cylinders) A_{C1}, A_{C2}, A_{B1}, A_{B2}, and A_{B3} of the clutches C1 and C2 and the brakes B1, B2, and B3, respectively. This line pressure PL is regulated to a value corresponding to the engine load or the like indicated by the accelerator depression amount or the throttle opening amount by a relief type pressure regulating valve or the like, not shown, from the output pressure from an electromagnetic oil pump or a mechanical oil pump that is driven by the engine 28. Also, the linear solenoid valves SL1 to SL5 all have basically the same structure. The output pressure (apply pressure) from the linear solenoid valves SL1 to SL5 is controlled (i.e., regulated) by changing the communication state between an input port and an output port or a drain port using the electromagnetic force of the solenoids such that the regulated output pressure is supplied to the hydraulic actuators A_{C1}, A_{C2}, A_{B1}, A_{B2}, and A_{B3}. Then, the solenoids provided in these linear solenoids valves SL1 to SL5 are individually energized by the ECU 44 such that the pressures of the hydraulic actuators A_{C1}, A_{C2}, A_{B1}, A_{B2}, and A_{B3} are individually controlled (i.e., regulated).

Also, in the hydraulic pressure circuit 42, a hydraulic switch S_{C1} for detecting the apply pressure of the clutch C1 is provided between the linear solenoid valve SL1 and the hydraulic actuator A_{C1} of clutch C1. Similarly, a hydraulic switch S_{C2} for detecting the apply pressure of the clutch C2 is provided between the linear solenoid valve SL2 and the hydraulic actuator A_{C2} of clutch C2. These hydraulic switches S_{C1} and S_{C2} produce output signals when the apply pressures of the clutch C1 and the clutch C2 are equal to or greater than a value near a predetermined value that is set in advance to determine when application is complete, such as the line pressure PL. As shown in FIG. 2, one or both of the clutch C1 and the clutch C2 is always applied to establish a forward speed. That is, in order to establish one of the forward speeds, either the clutch C1 or the clutch C2 must be applied. Also, every time a shift is performed, the clutches C and the brakes B function as input apply elements (i.e., apply elements that are applied during a shift).

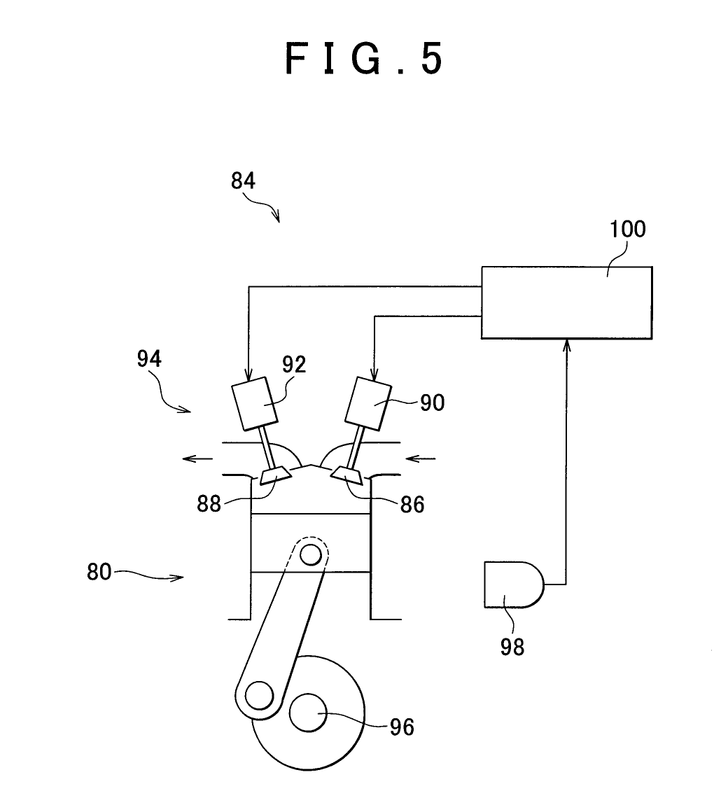

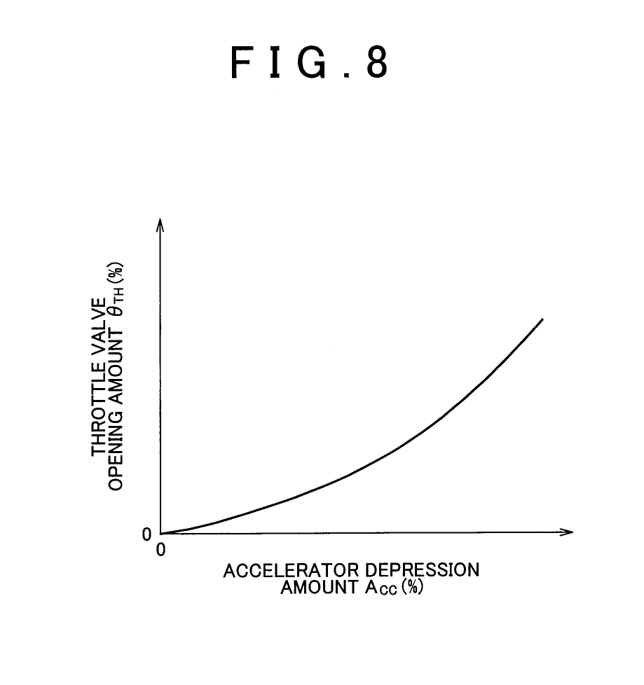

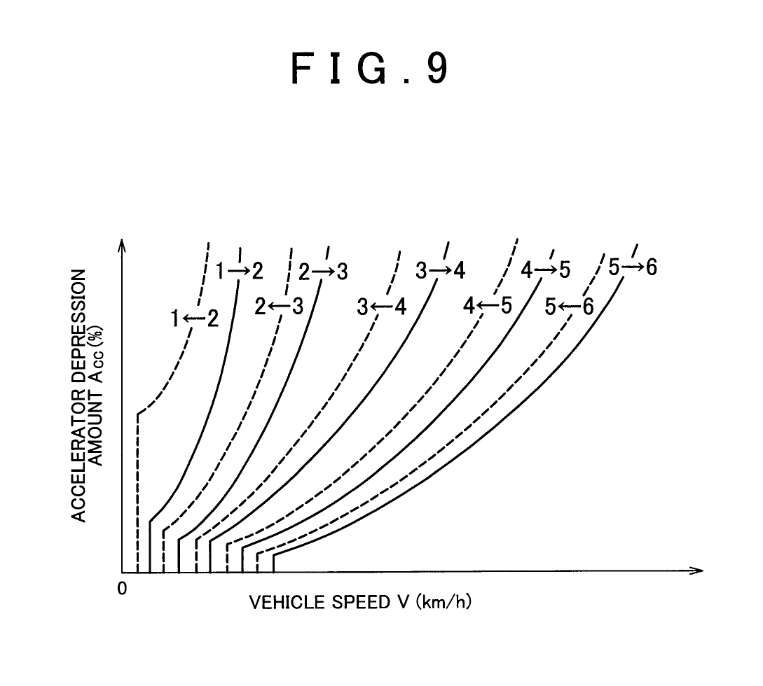

FIG. 4 is a block line diagram illustrating an electrical control system provided in the vehicle for controlling the vehicular power outputting apparatus 8 and the like. The ECU 44 shown in FIG. 4 is a so-called micro-computer that includes, for example, ROM, RAM, a CPU, and an input/output interface and the like. The CPU processes input signals according to programs stored in advance in the ROM while using the temporary storage function of the RAM. For example, the CPU performs various controls related to the power outputting apparatus 8, such as throttle opening amount control to control the opening angle of the electronic throttle valve 74, i.e., the throttle opening amount θ_{TH} (%), based on the actual accelerator depression amount A_{CC} (%) and or like from a pre-stored relationship such as that shown in FIG. 8, shift control to automatically switch speeds in the automatic transmission 10 based on the actual accelerator depression amount A_{CC} (%) or the throttle opening amount θ_{TH} (%) and the vehicle speed V (km/h) or the like from a pre-stored relationship such as that shown in FIG. 9, ignition control of the engine 28 described above, and variable valve timing control via the valve driving control apparatus 84 (see FIG. 5).

Also, the depression (i.e., operation) amount A_{CC} of an accelerator pedal 46, which is referred to as the so-called accelerator depression amount is detected by an accelerator depression amount sensor 48 and a signal indicative of that accelerator depression amount A_{CC} is sent to the ECU 44. The accelerator pedal 46 is a pedal which the driver depresses more according to a desire for more output, i.e., according to an increase in the demanded output amount, and corresponds to an accelerator operation member. Thus, the accelerator depression amount A_{CC} corresponds to the demanded output amount. Also, various sensors and switches the like are also provided. These include, for example, an engine speed sensor 50 for detecting the speed NE of the engine 28; an intake air amount sensor 52 for detecting an intake air amount (i.e., quantity) Q of the engine 28; an intake air temperature sensor 54 for detecting the temperature T_{A} of the intake air; a throttle sensor 56 with an idle switch for detecting when the electronic throttle valve 74 that controls the intake air of the engine 28 is completely closed (indicative of an idle state) and detecting the opening amount θ_{TH} when the electronic throttle valve 74 is open; a vehicle speed sensor 58 for detecting the vehicle speed V (which corresponds to the rotation speed N_{OUT} of the output rotating member 24); a coolant temperature sensor 60 for detecting a coolant temperature T_{W} of the engine 28; a brake switch 64 for detecting an operation of a foot brake pedal 62 which is a service brake; a shift lever position sensor 68 for detecting a position (i.e., the operating position) P_{SH} of a shift lever 66; a turbine speed sensor 70 for detecting a turbine speed N_{T} (=the rotation speed N_{IN} of the input shaft 22); and an AT fluid temperature sensor 72 for detecting the AT fluid temperature T_{OIL} which is the temperature of the hydraulic fluid in the hydraulic control circuit 42. These sensors and switches send signals indicative of the engine speed NE, the intake air amount Q, the intake air temperature T_{A}, the throttle valve opening amount θ_{TH}, the vehicle speed V, the engine coolant temperature T_{W}, a brake operation, the position P_{SH} of the shift lever 66, the turbine speed NT, and the AT fluid temperature T_{OIL} and the like to the ECU 44.

The electronic throttle valve 74 for controlling the intake air amount allowed into the engine 28 is provided in an intake conduit of the engine 28. The opening angle of the throttle valve 74, i.e., the throttle valve opening amount θ_{TH}, can be changed by a throttle actuator 76. In the opening/closing control of this electronic throttle valve 74, for example, the throttle actuator 76 controls the throttle valve opening amount θ_{TH} so as to realize a target engine torque T_{E}* obtained based on the actual engine speed NE and the accelerator depression amount A_{CC} from a stored relationship (i.e., an engine torque map) which is obtained through testing beforehand of the engine speed NE and an engine torque estimated value T_{E0}, in which the throttle valve opening amount θ_{TH} is used as a parameter, as shown in FIG. 8, for example.

The engine 28 includes a plurality (four are shown in FIG. 4) of cylinders 80a, 80b, 80c, and 80d (hereinafter these will simply be referred to as “cylinders 80” when there is no particular need to differentiate between them), each of which has a combustion chamber for driving a piston by the combustion of fuel. Power for driving the vehicle is generated by burning fuel in the combustion chambers of these cylinders 80. Also, ignition devices 82a, 82b, 82c, and 82d (hereinafter these will simply be referred to as “ignition devices 82” when there is no particular need to differentiate between them) such as spark plugs are provided in the cylinders 80. Fuel supplied to the combustion chambers of the cylinders 80 is combusted by sparks produced by the ignition devices 82. Also, the ignition devices 82 in the cylinders 80 can control the sparking (in the cylinders 80) individually.

FIG. 5 is a detailed view of a valve driving control apparatus 84 provided in the engine 28. As shown in FIG. 5, an intake valve 86 and an exhaust valve 88, which are open/close control valves, i.e., electromagnetically driven valves, are provided in each of the cylinders 80 of the engine 28. The timing at which the valves 86 and 88 are opened and closed (i.e., the opening/closing timing), the duration for which the valves 86 and 88 are open and closed (i.e., the open/closed duration), and the lift amount of the valves 86 and 88 and the like are electrically controlled according to commands from the ECU 44. The engine 28 also includes a variable valve timing mechanism 94 and a valve driving controller 100. The variable valve timing mechanism 94 includes the intake and exhaust valves 86 and 88 as well as electromagnetic actuators 90 and 92 which are electric actuators that drive the intake and exhaust valves 86 and 88 open and closed. The valve driving controller 100 controls the opening/closing timing, lift amount, and operating angle (i.e., the opening/closing speed) of the intake and exhaust valves 86 and 88 according to signals from a crankshaft rotation angle sensor 98 that detects the rotation angle of a crankshaft 96. This valve driving controller 100 not only changes the opening/closing timing and the like to the optimum timing according to the engine load, but also performs control to realize the opening/closing timings to operate the engine 28 with four cycles as well as two according to an operation cycle switching command. Also, the valve driving controller 100 can also control the speed NE of the engine itself by changing the operation timing of the intake and exhaust valves 86 and 88 and changing the number of cylinders operated. For example, opening and closing the exhaust valve 88 according to normal control while keeping the intake valve 86 closed generates rotational resistance against the piston during the compression stroke. This rotational energy can be used to force a quick drop in the engine speed NE, while the rate of change in the engine speed NE can be adjusted by controlling the opening amount of the intake valve 86.

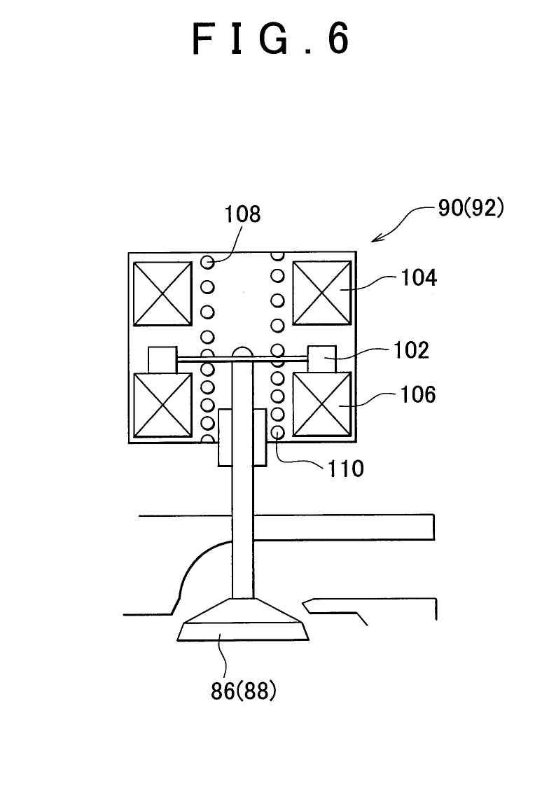

FIG. 6 is a detailed view of the electromagnetic actuators 90 and 92 provided in the valve driving control apparatus 84. As shown in FIG. 6, the electromagnetic actuators 90 and 92 each include a magnetic disc-shaped movable member 102 that is connected to the intake valve 86 or the exhaust valve 88 and movably supported in the axial direction of that intake valve 86 or exhaust valve 88, a pair of electromagnets 104 and 106 which are provided in positions sandwiching the movable member 102 for selectively attracting that movable body 102, and a pair of springs 108 and 110 that urge the movable member 102 toward the center position. The intake valve 86 and the exhaust valve 88 correspond to electric opening/closing valves that can be electrically controlled to open and close.

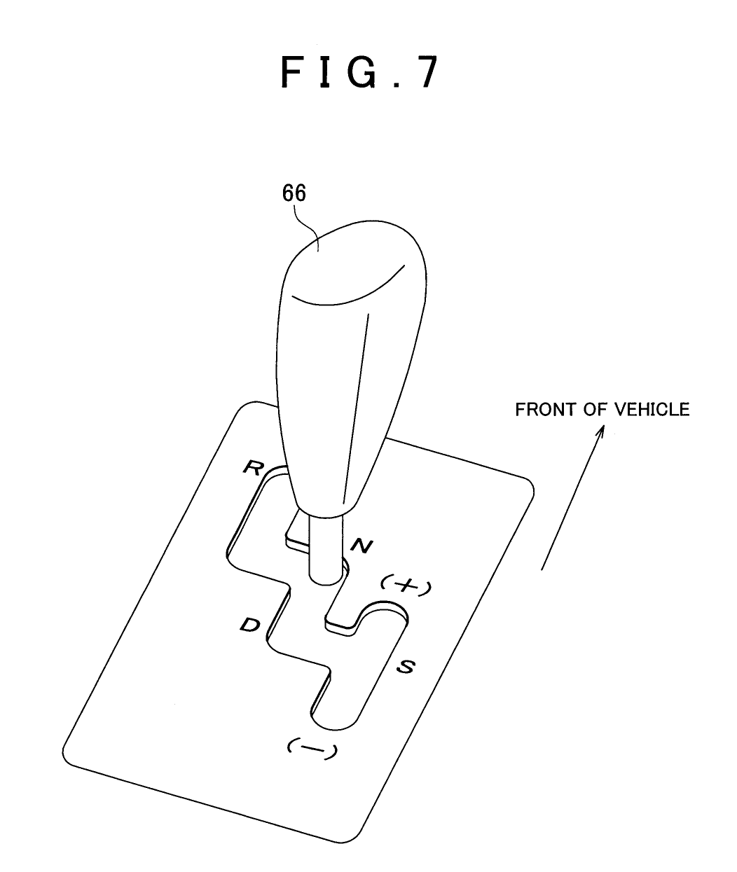

The shift lever 66 is provided near the driver's seat, for example, and can be manually operated into any one of five lever positions, i.e., “P”, “R”, “N”, “D”, and “S”, as shown in FIG. 7. The “P” position (i.e., range) is a park position that both places the automatic transmission 10 in a neutral state in which the power transmitting path in the automatic transmission 10 is interrupted and mechanically prevents the output rotating member 24 from rotating (i.e., locks it against rotation) by a mechanical parking mechanism. The “R” position is a reverse running position for rotating the output rotating member 24 of the automatic transmission 10 in the reverse direction. The “N” position is a neutral position for placing the automatic transmission 10 in a neutral state in which the power transmitting path in the automatic transmission 10 is interrupted. The “D” position is a forward running position that executes automatic shift control using all of the forward speeds, i.e., first speed “1st” through sixth speed “6th”, in a shift range (the D range) within which the automatic transmission 10 is allowed to shift. The “S” position is a forward running position that enables a manual shift, i.e., a shift corresponding to a manual operation, by switching among a plurality of various shift ranges that restrict the speed change range, i.e., a plurality of various shift ranges each having a different highest speed that can be shifted into (hereinafter simply referred to as the “highest speed”). Incidentally, this example embodiment describes a mode for changing the highest speed by operating the shift lever 66. However, when the shift lever 66 is in the “S” position, for example, it is also possible to shift into the higher speed by operating the shift lever 66 into the (+) position shown in FIG. 7, and shift into the lower speed by operating the shift lever 66 into the (−) position shown in FIG. 7.

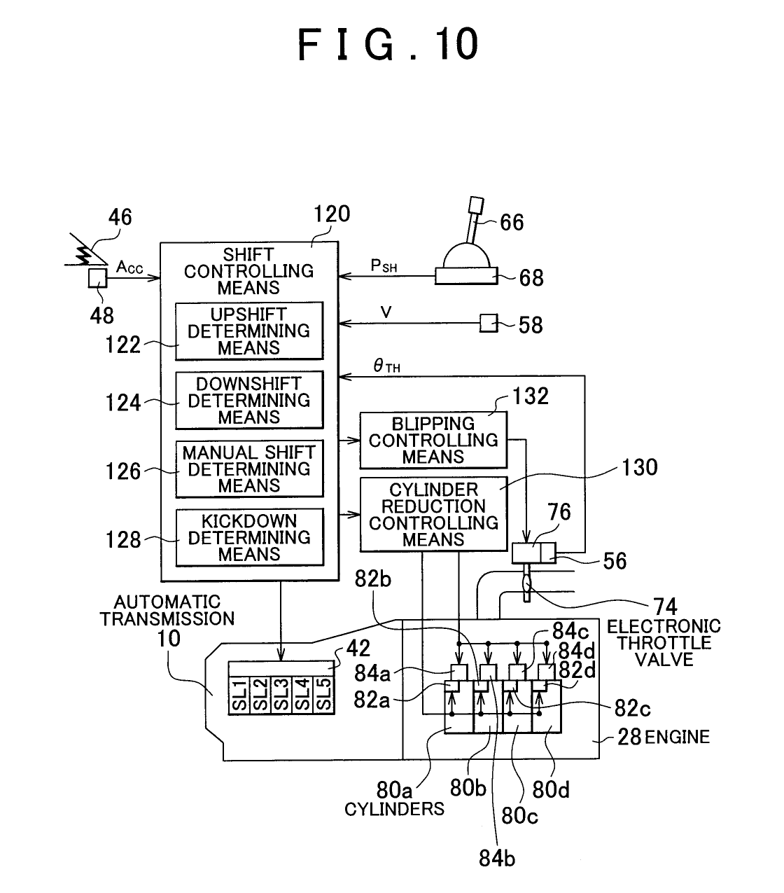

FIG. 10 is a functional block line diagram showing the main portions of the control function provided in the ECU 44. Shift controlling means 120 shown in FIG. 10 controls a shift operation by the automatic transmission 10. For example, the shift controlling means 120 sets the speed of the automatic transmission 10 based on the actual accelerator depression amount A_{CC} (%) or the throttle opening amount θ_{TH} (%) and the vehicle speed V (km/h) from a pre-stored relationship, i.e., a shift map, such as that shown in FIG. 9, for example. The shift controlling means 120 then controls the linear solenoid valves SL1 to SL5 provided in the hydraulic control circuit 42 to establish the set speed and apply states. The shift lines shown in the shift map in FIG. 9 are used to determine whether the operating point represented by the actual accelerator depression amount A_{CC} (%) or throttle opening amount θ_{TH} (%) and the actual vehicle speed V has crossed a shift line. That is, the shift lines on the shift map are used to determine whether the actual vehicle speed V has crossed a value (i.e., a shift point speed) at which a shift should be executed on the shift map.

The shift controlling means 120 includes upshift determining means 122, downshift determining means 124, manual shift determining means 126, and kickdown determining means 128, and controls the hydraulic control circuit 42 to establish the speed and apply states according to the determinations of these determining means. The upshift determining means 122 determines whether a command has been output for an upshift, i.e., a shift into a higher shift range (i.e., a speed with a larger speed ratio) in the automatic transmission 10. More specifically, the upshift determining means 122 determines whether a value at which an upshift from a lower speed to a higher speed should be executed has been exceeded based on the actual accelerator depression amount A_{CC} (%) or the throttle opening amount θ_{TH} (%) and the vehicle speed V (km/h) from a shift map such as that shown in FIG. 9 described above.

The downshift determining means 124 determines whether a command has been output for a downshift, i.e., a shift into a lower shift range (i.e., a speed with a smaller speed ratio) in the automatic transmission 10. More specifically, the upshift determining means 122 determines whether a value at which a downshift from a higher speed to a lower speed should be executed has been exceeded based on the actual accelerator depression amount A_{CC} (%) or the throttle opening amount θ_{TH} (%) and the vehicle speed V (km/h) from a shift map such as that shown in FIG. 9 described above.

The manual shift determining means 126 determines whether a command has been output to shift the automatic transmission 10 according to a manual operation. More specifically, when the shift lever 66 is in the “S” position, for example, the manual shift determining means 126 determines whether a command has been output for a shift operation as a result of an operation to shift the shift lever 66 into the (+) or the (−) position shown in FIG. 7.

The kickdown determining means 128 determines whether a command has been output to shift the automatic transmission 10 in response to a downshift performed as a result of the accelerator pedal 46 being suddenly depressed when accelerating. This type of downshift is known as a kickdown. For example, the kickdown determining means 128 determines that a command has been output for a shift operation according to a kickdown when the depression speed of the accelerator pedal 46, i.e., the speed at which the actual accelerator depression amount A_{CC} that is supplied via a signal from the accelerator depression amount sensor 48 changes, is equal to or greater than a predetermined value.

Cylinder reduction controlling means 130 performs cylinder reduction control to stop at least some of the plurality of cylinders 80 provided in the engine 28 from generating power when there is a downshift in the automatic transmission 10, i.e., when the determination by the downshift determining means 124 is positive. For example, the cylinder reduction controlling means 130 stops the combustion of fuel (i.e., stops the sparking by the ignition devices 82) in two of the four cylinders 80 provided in the engine 28, as well as stops the intake valves 86 provided in those two cylinders 80. Also, the exhaust valves 88 in those cylinders 80 may also be stopped. Further, this cylinder reduction controlling means 130 executes the cylinder reduction control when there is a downshift in the automatic transmission 10 according to a manual operation, i.e., when the determinations by both the downshift determining means 124 and the manual shift determining means 126 are positive. Also, the cylinder reduction controlling means 130 may also execute the cylinder reduction control when there is a downshift in the automatic transmission 10 due to a kickdown, i.e., when the determination by the kickdown determining means 128 is positive.

The cylinder reduction controlling means 130 executes the cylinder reduction control when the engine 28 is operating under a low load of equal to or less than a predetermined threshold value. More specifically, the cylinder reduction controlling means 130 determines whether the vehicle is being actively driven by the engine 28 or not based on the vehicle speed V detected by the vehicle speed sensor 58 and the accelerator depression amount A_{CC} detected by the accelerator depression amount sensor 48 from a preset relationship. When it has been determined that the vehicle is not being actively driven by the engine 28, the cylinder reduction controlling means 130 executes the cylinder reduction control. On the other hand, when it has been determined that the vehicle is being actively driven by the engine 28, the cylinder reduction controlling means does not execute the cylinder reduction control. Also, the cylinder reduction controlling means 130 may also execute the cylinder reduction control when the vehicle speed V detected by the vehicle speed sensor 58 is less than a predetermined value and not execute the cylinder reduction control when the vehicle speed V is equal to or greater than the predetermined value.

Blipping controlling means 132 performs blipping control that temporarily increases the rotation speed of the input rotating element provided in the automatic transmission 10 by the engine 28 during a shift operation in the automatic transmission 10. Also, the opening amount of the electronic throttle valve 74 for controlling the intake air of the engine 28, i.e., the throttle opening amount θ_{TH}, is set larger when the cylinder reduction control is performed by the cylinder reduction controlling means 130 than it is when that cylinder reduction control is not performed. For example, when the cylinder reduction controlling means 130 stops two of the four cylinders 80 provided in the engine 28 from generating power, the opening amount of the electronic throttle valve 74 is controlled via the throttle actuator 76 so that the throttle opening amount θ_{TH} is twice what it is when the cylinder reduction control is not performed. Also, when the cylinder reduction controlling means 130 stops one of the four cylinders 80 provided in the engine 28 from generating power, the opening amount of the electronic throttle valve 74 is controlled via the throttle actuator 76 so that the throttle opening amount θ_{TH} is three-quarters what it is when the cylinder reduction control is not performed. In this way, when the cylinder reduction control is performed by the cylinder reduction controlling means 130, the blipping controlling means 132 preferably controls the throttle opening amount θ_{TH} to obtain output torque equivalent to that which is obtained when power is generated while cylinder reduction control is not being performed, i.e., when power is generated using all of the cylinders 80 provided in the engine 28.

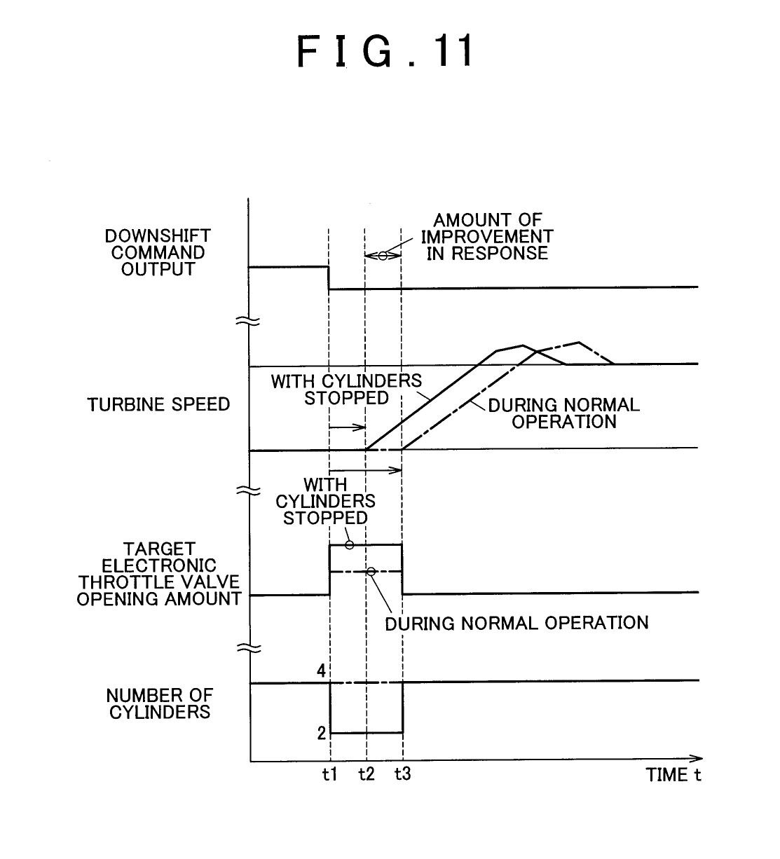

FIG. 11 is a time chart illustrating the improvement in shift response according to the cylinder reduction control that is executed by the cylinder reduction controlling means 130. In the drawing, the solid line shows a case in which the cylinder reduction control according to this example embodiment is performed by the cylinder reduction controlling means 130, while the alternate long and short dash line shows a case in which normal control is performed, i.e., in which the cylinder reduction control is not performed. As shown in FIG. 11, when a command to downshift the automatic transmission 10, i.e., shift from a higher speed to a lower speed in the automatic transmission 10, is output at time t1, in the control of this example embodiment, power stops being generated in two of the four cylinders 80 of the engine 28, and a target electronic throttle valve opening amount is set such that the throttle opening amount θ_{TH}, which is the opening amount of the electronic throttle valve 74, doubles. Here, as shown by the change in the turbine speed in FIG. 11, the turbine speed NT starts to increase from time t2 with the control of this example embodiment in which the cylinder reduction control is performed. In comparison, the turbine speed NT starts to increase from time t3 with normal control, i.e., when the cylinder reduction control is not performed. The reason why the turbine speed NT starts to rise faster when the cylinder reduction control according to this example embodiment is performed than when that cylinder reduction control is not performed is because there is less pumping loss from the intake negative pressure of the entire engine 28 due to the fact that there are fewer cylinders 80 generating power. The time difference (=t3−t2) between the times that the turbine speed NT starts to rise corresponds to the amount of improvement in the response from the control of this example embodiment. Also, reducing the cylinders 80 by two in the cylinder reduction control and doubling the throttle opening amount θ_{TH} suppresses a decline in output torque of the engine 28 that otherwise might occur due to cylinder reduction control. As a result, torque equivalent to that during normal control, i.e., control in which cylinder reduction control is not performed, can be input to the automatic transmission 10.

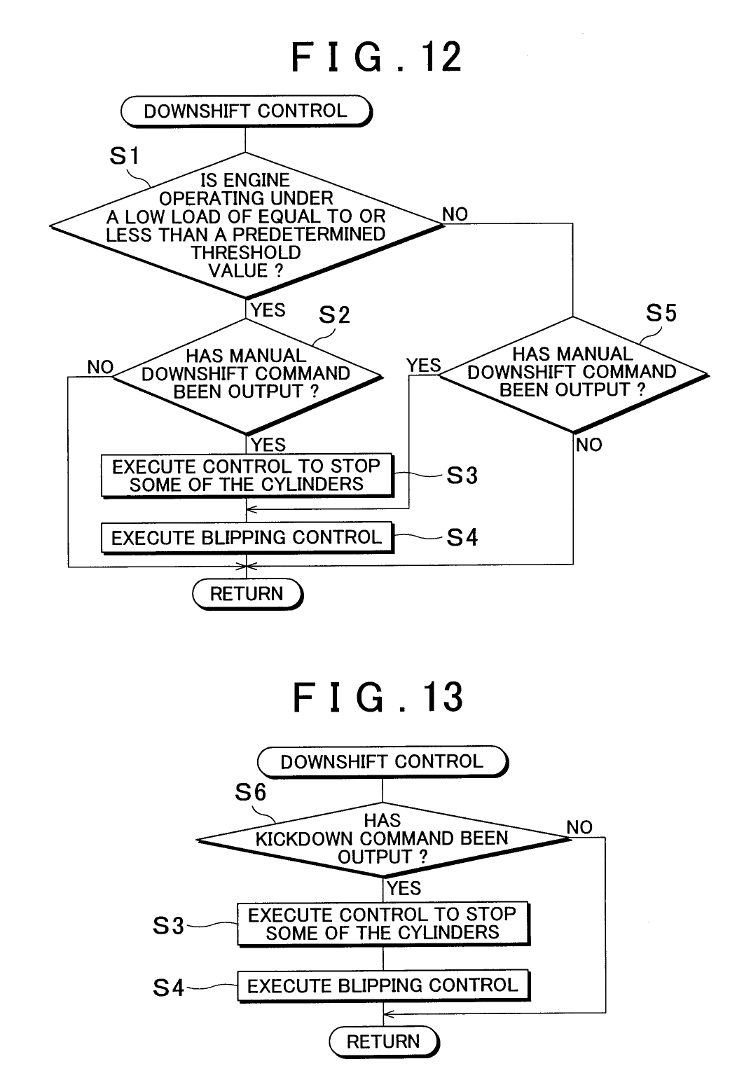

FIG. 12 is a flowchart illustrating the main part of a downshift control routine executed by the ECU 44. This routine is repeatedly executed in extremely short time cycles of approximately several msec to several tens of msec, for example.

First in step S1, it is determined whether the engine 28 is operating under a low load of equal to or less than a predetermined threshold value. When the determination in step S1 is no, steps S5 and thereafter are performed. If, on the other hand, the determination in step S1 is yes, then it is determined in step S2 whether a command has been output for a downshift operation in the automatic transmission 10 according to a manual operation by the shift lever 66 or the like. If the determination in step S2 is no, this cycle of the routine ends. If, on the other hand, the determination in step S2 is yes, then the combustion of fuel in two of the four cylinders 80 of the engine 28 is stopped and the intake valves 86 of those cylinders 80 are stopped in step S3 which corresponds to the operation of the cylinder reduction controlling means 130. Next in step S4 which corresponds to the operation of the blipping controlling means 132, the opening amount of the electronic throttle valve 74 is controlled via the throttle actuator 76 so that the throttle amount θ_{TH} is doubled, i.e., is twice what it was. Then this cycle of the routine ends. In step S5, it is determined whether a command has been output for a downshift operation in the automatic transmission 10 according to an manual operation using the shift lever 66 or the like. If the determination in step S5 is yes, steps S4 and thereafter are performed. If, on the other hand, the determination in step S5 is no, this cycle of the routine ends. In the foregoing routine, step S2 corresponds to the operation of the downshift determining means 124 and step S5 corresponds to the operation of the manual shift determining means 126.

FIG. 13 is a flowchart illustrating an example of the main part of another downshift control routine executed by the ECU 44. This routine is repeatedly executed in extremely short time cycles of approximately several msec to several tens of msec, for example. Incidentally, in this control, steps that are the same as those in the routine shown in FIG. 12 described above will be denoted by the same reference numerals and descriptions of those steps will be omitted. That is, in the control shown in FIG. 13, first in step S6 which corresponds to the operation of the kickdown determining means 128, it is determined whether a command to downshift has been output as a result of the accelerator pedal 46 being suddenly depressed when accelerating, i.e., whether a command has been output to shift the automatic transmission 10 as a result of a kickdown. If the determination in step S6 is yes, steps S3 and thereafter are performed. If, on the other hand, the determination in step S6 is no, this cycle of the routine ends.

In this way, a control apparatus of a vehicular power outputting apparatus 8 according to this example embodiment which temporarily increases the rotation speed of the input rotating element (input shaft 22) provided in an automatic transmission 10, which is a stepped automatic transmission, using the engine 28 which is an internal combustion engine during a downshift in the automatic transmission 10 includes the cylinder reduction controlling means 130 that performs cylinder reduction control which stops at least some of the plurality of cylinders 80 of the engine 28 from generating power during a downshift in the automatic transmission 10. As a result, the pumping loss of the engine 28 is reduced so the speed of the engine 28 can be increased faster. That is, it is possible to provide a control apparatus of a vehicular power outputting apparatus 8, which improves shift response.

Also, when cylinder reduction control is performed by the cylinder reduction controlling means 130, the opening amount of the electronic throttle valve 74 for controlling the intake air of the engine 28 is set larger than it is when the cylinder reduction control is not performed. As a result, a reduction in output torque of the engine 28 that would otherwise occur due to the cylinder reduction control can be suppressed while the shift response can be improved.

Further, the cylinder reduction controlling means 130 performs the cylinder reduction control during a downshift of the automatic transmission 10 according to a manual operation so the shift response during a manual downshift can be improved.

Also, the cylinder reduction controlling means 130 performs the cylinder reduction control during a downshift of the automatic transmission 10 as a result of a kickdown so the shift response during a kick downshift can be improved.

While the invention has been described with reference to example embodiments thereof, it is to be understood that the invention is not limited to the described embodiments or constructions. To the contrary, the invention is intended to also cover various modifications and equivalent arrangements.

For example, the foregoing example embodiment described a case in which the invention was applied to the vehicular power outputting apparatus 8 provided with a gasoline engine that ignites fuel using the ignition device 82 as an internal combustion engine, but the invention is not limited to this. For example, the invention may also be applied to a vehicular power outputting apparatus provided with an internal combustion engine such as a diesel engine that burns fuel by compressing air in a cylinder into which fuel has been injected. Also, in this case, the cylinder reduction controlling means 130 performs the cylinder reduction control by controlling the fuel injection into the cylinder.

Also, the foregoing example embodiment described a case in which the invention was applied to the vehicular power outputting apparatus 8 provided with a four cylinder engine having four cylinders 80. It goes without saying, however, that the invention may also be applied to a vehicular power outputting apparatus provided with a 6 cylinder engine or a twelve cylinder engine or the like. Also, in this case, the number of cylinders that are stopped (i.e., in which power is stopped being generated) by the cylinder reduction controlling means 130 may be set appropriately according to the mode of the vehicular power outputting apparatus to which that engine is applied.

In addition, while the various elements of the example embodiments are shown in various combinations and configurations, which are exemplary, other combinations and configurations, including more, less or only a single element, are also within the spirit and scope of the invention.

What is claimed is:

1. A vehicular power outputting apparatus, comprising:
an internal combustion engine that has a plurality of cylinders for generating power to drive a vehicle;
a stepped transmission that transmits power generated by the internal combustion engine to a drive shaft of the vehicle; and
a controller which performs a cylinder reduction control that stops at least some of a plurality of cylinders provided in the internal combustion engine from generating power and, using the internal combustion engine, temporarily increases the rotation speed of an input rotating element provided in the stepped transmission during a downshift of the stepped transmission.

2. The vehicular power outputting apparatus according to claim 1, wherein when the controller performs the cylinder reduction control, the rotation speed of the input rotating element is temporarily increased by the internal combustion engine by setting an opening amount of a throttle valve for controlling an amount of intake air allowed into the internal combustion engine larger than the opening amount of the throttle valve when the controller does not perform the cylinder reduction control.

3. The vehicular power outputting apparatus according to claim 1, wherein the controller performs the cylinder reduction control during a downshift of the stepped transmission according to a manual operation.

4. The vehicular power outputting apparatus according to claim 1, wherein the controller performs the cylinder reduction control during a downshift of the stepped transmission as a result of a kickdown.

5. A control method for a vehicular power outputting apparatus, comprising:
determining whether a downshift condition of a stepped transmission of the vehicular power outputting apparatus is satisfied, and
when the downshift condition is satisfied, performing a cylinder reduction control that stops at least some of a plurality of cylinders provided in an internal combustion engine of the vehicular power outputting apparatus from generating power and temporarily increasing the rotation speed of an input rotating element provided in the stepped transmission using the internal combustion engine.

6. The control method according to claim 5, further comprising:
determining whether the vehicle is being actively driven by the internal combustion engine,
wherein the cylinder reduction control is not performed when the vehicle is not being actively driven by the internal combustion engine.
